(19) United States
(12) Patent Application Publication
(10) Pub. No.: US 2015/0103992 A1
(43) Pub. Date: Apr. 16, 2015

(54) SYSTEMS AND METHODS FOR NEAR REAL-TIME VOICE CALLING TO A PLURALITY OF RECIPIENTS

(71) Applicant: Phonio, Inc., San Francisco, CA (US)

(72) Inventors: Matthew Caspari, Berkeley, CA (US); Dan Soha, San Francisco, CA (US); Conrad Decker, Jacksonville, FL (US)

(73) Assignee: Phonio, Inc., San Francisco, CA (US)

(21) Appl. No.: 14/515,361

(22) Filed: Oct. 15, 2014

Related U.S. Application Data
(60) Provisional application No. 61/891,355, filed on Oct. 15, 2013.

(51) Int. Cl. H04M 3/56

(52) U.S. Cl. CPC H04M 3/56
USPC 379/202.01

(57) ABSTRACT

A phone system includes an application server and a phone server. The application server is configured to provide a phone number to a source caller to connect to the phone system, and to receive a subscription of listeners associated with the source caller. The phone server is configured to receive voice call content from the source caller using the phone number. The application server is then configured to cause the phone server to phone dial the subscription of listeners to provide the voice call content to the subscription of listeners based on a validation of the source caller.

### CROSS-REFERENCE TO RELATED APPLICATIONS

The present application claims the benefit of and priority to U.S. Pat. Appl. No. 61/891,355, entitled “SYSTEMS AND METHODS FOR REAL-TIME VOICE CALLING,” filed Oct. 15, 2013, which is incorporated herein by reference in its entirety.

### BACKGROUND

Conducting what can be perceived as real-time or near real-time voice calls from an individual to a large number of subscribers has several technological problems. One technical problem is the number of “calls per second” that can be initiated by an individual. Another technical problem is the low quality of “conference calls” when the number of active participants exceeds a certain number of people (e.g., 200 people). Yet another technical problem is the onboarding process for configuring the system for one-to-many communication in a way that operates with existing dialing and contact technologies of the user's phone.

### SUMMARY

Embodiments of the present disclosure relate to systems and methods for making voice calls in a batched process. More particularly, but not by way of limitation, the embodiments disclosed herein are related to systems and methods of making real-time voice calls from a source (i.e., a person of interest) to a plurality of subscribers.

One embodiment relates to a phone system. The phone system includes an application server configured to provide a phone number to a source caller to connect to the phone system, and to receive a subscription of listeners associated with the source caller. The phone system also includes a phone server configured to receive voice call content from the source caller using the phone number. The application server is configured to cause the phone server to phone dial the subscription of listeners to provide the voice call content to the subscription of listeners based on a validation of the source caller. According to one embodiment, the phone call is from one or a limited number of source callers to a plurality of listeners. By reducing the number of active participants on the call, the phone system is able to transmit the voice call content to a relatively greater number of listeners at a relatively high level of quality.

Another embodiment of the present disclosure relates to a phone system. The phone system includes a VIP onboarding module structured to facilitate registration by a VIP with the phone system. The VIP onboarding module is also structured to provide a phone number to the VIP based on registration. The phone system also includes a listener onboarding module structured to facilitate registration by a listener with the phone system. The phone system further includes a listener profile module structured to receive a selection to follow the VIP. The phone system still further includes a call module structured to receive voice call content from the VIP and set up a phone call with one or more listeners that have selected to follow the VIP. According to one embodiment, the phone call is uni-directional in that the VIP is able to transmit the voice call content in real or near real-time, but the one or more listeners are unable to respond back to the VIP or the other listeners. This reduces the bandwidth needed to support the phone system, thereby enabling relative efficient phone calls to take place that closely mimic an actual phone conversation.

Still another embodiment of the present disclosure relates to a method of operating a phone system by providing a phone number to a source caller to connect to the phone system; receiving a subscription of listeners associated with the source caller; receiving voice call content from the source caller using the phone number; and initiating an outgoing call for each listener in the subscription of listeners to provide the voice call content to the subscription of listeners.

Yet another embodiment of the present disclosure relates to a computerized calling system. The computerized calling system includes a phone server configured to receive a voice phone call from a source caller, and an application server coupled to the phone server and configured to receive call information and voice data from the phone server. The application server is configured to cause the phone server to automatically dial a plurality of subscribers previously associated with the source caller such that subscribers near each other receive the voice data from the source caller at substantially the same time.

Another embodiment of the present disclosure relates to a machine-implemented method for initiating a plurality of calls. The method includes receiving, by a server, a real-time voice call from a person of influence. The method further includes, determining, by a data processing device, a first tier of subscribers, for real-time streaming, from a plurality of subscribers. The method further includes streaming, by a server, the real-time voice call from the person of influence to the first tier of subscribers.

Yet another embodiment of the present disclosure relates to a computer system including a memory and one or more processors communicatively coupled to the memory. One or more programs are stored in the memory and are executed by the one or more processors. A server is coupled to at least one of the one or more processors and is instructed by at least one of the one or more programs to handle a received real-time voice call from a person of influence. A data processing device is coupled to the at least one of the one or more processors and is instructed by the at least one of the one or more programs to determine a first tier of subscribers for real-time streaming from a plurality of subscribers. A server is coupled to at least one of the one or more processors and is instructed by at least one of the one or more programs to stream the real-time voice call from the person of influence to the first tier of subscribers.

Another embodiment of the present disclosure relates to a machine-implemented method. The method includes receiving, by a server, a real-time voice call from a person of influence. The method further includes determining, by a data processing device, a first tier of subscribers for real-time streaming from a plurality of subscribers. The method further includes streaming, by a server, the real-time voice call from the person of influence to the first tier of subscribers. In one embodiment, the determining, by the data processing device, of the first tier of subscribers further includes implementing, by the data processing device, a first delay between the receiving of the real-time voice call from the person of influence and the streaming of the real-time voice call. Determining the first tier of subscribers further includes implementing, by the data processing device, a second delay between the streaming of the real-time voice call to the first tier of subscribers and the streaming of the real-time voice call to a second tier of subscribers. Determining the first tier of subscribers further includes minimizing, by the data processing device, the second delay by increasing the first delay. In one embodiment, the method further includes modifying, by a serve, the real-time voice call from the person of influence with an advertisement. In one embodiment, the method further includes modifying, by a server, the real-time voice call from the person of influence with an audio enhancement. In one embodiment, the determining, by the data processing device, of the first tier of subscribers further includes analyzing, by the data processing device, a history of prior real-time voice calls to a subscriber from the person of influence or a second person of influence. The determining of the first tier of subscribers may further include analyzing, by the data processing device, a subscriber priority rating. The determining of the first tier of subscribers may further include: analyzing, by a data processing device, a social network of the plurality of subscribers; analyzing, by a data processing device, an area code of the plurality of subscribers; and analyzing, by a data processing device, a GPS-determined location of the plurality of subscribers.

In various embodiments, the first tier of subscribers may be between about 2 and 1,000 subscribers, between about 1,001 and 10,000 subscribers, between about 10,001 and 100,000 subscribers, or between about 100,001 and 1,000,001 subscribers. In this regard, the demarcations of tiers may be based on the number of subscribers.

Another embodiment of the present disclosure relates to a non-transitory medium, readable through one or more processors and including instructions embodied therein that are executable through the one or more processors. The instructions include instructions to receive, by a server, a real-time voice call from a person of influence. The instructions further include instructions to determine, by a data processing device, a first tier of subscribers for real-time streaming from a plurality of subscribers. The instructions further include instructions to stream, by a server, the real-time voice call from the person of influence to the first tier of subscribers.

Another embodiment of the present disclosure relates to a computer system. The computer system includes a memory and one or more processors communicatively coupled to the memory. The computer system further includes one or more programs, stored in the memory and executed by the one or more processors. The computer system further includes a server coupled to at least one of the one or more programs to receive a real-time voice call from a person of influence. The computer system further includes a data processing device coupled to at least one of the one or more processors and instructed by at least one of the one or more programs to determine a first tier of subscribers for real-time streaming from a plurality of subscribers. The computer system further includes a server coupled to at least one of the one or more processors and instructed by at least one of the one or more programs to stream the real-time voice call from the person of influence to the first tier of subscribers.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is a block diagram of a system for near real-time voice calling, according to an exemplary embodiment;

FIG. 2 is a block diagram of the system of FIG. 1, illustrating a process of a VIP providing a voice message to be transmitted to a plurality of listeners via phone, according to an exemplary embodiment;

FIG. 3 is a flow chart of a process for receiving a VIP voice message and transmitting the message to a plurality of listeners via phone, according to an exemplary embodiment;

FIG. 4 is a detailed block diagram of the application server of the phone system, according to an exemplary embodiment;

FIG. 5 is a detailed block diagram of a VIP call module of the application server of FIG. 4, according to an exemplary embodiment;

FIG. 6 is a flow chart of a process for providing a VIP voice call content to a plurality of listeners via phone, according to an exemplary embodiment;

FIG. 7 is a flow chart of a VIP onboarding process, according to an exemplary embodiment;

FIG. 8 is a flow chart of a listener onboarding process, according to an exemplary embodiment;

FIG. 9 is a detailed block diagram of a VIP profile module configured to manage a VIP profile, according to an exemplary embodiment;

FIG. 10 is a detailed block diagram of a listener profile module configured to manage a listener profile, according to an exemplary embodiment; and

FIG. 11 is a flow chart of a process for contacting a listener and providing the listener with a voice message from a VIP, according to an exemplary embodiment.

### DETAILED DESCRIPTION

Referring generally to the Figures, systems and methods are disclosed herein which enable influential people, brands, companies, and organizations (hereinafter referred to in the disclosure as “VIPs” or “source callers”) to make phone calls to their audiences (hereinafter referred to in the disclosure as “listeners”), to deliver a real-time call experience to the listeners. The systems and methods allow for providing the feel of real-time voice calls from a VIP to a listener rather than the feel of recorded voice calls. In other words, the phone system herein may allow for the ability to create a large number of phone calls that feel instantaneous or real-time to the listeners. Further, it allows a VIP to make a real-time voice call to many listeners just as easily as if the VIP were making the same voice call to a single listener.

For VIPs, the real-time voice call aspect allows a level of privacy and protection that is stronger than with other social media services. For example, other social media services allow posts and/or tweets to remain on the Internet and in public space indefinitely. The continuous presence of the social media content may be problematic for the VIPs. In contrast, the systems and methods herein provides a temporary way to communicate with listeners, as the phone call is not typically recorded by recipients and made available in the public space.

One bottleneck to enable large-scale real-time calls is the number of “calls per second” that can be initiated. For a large network of VIPs and listeners, it may be feasible to allow 100, 1,000, or 10,000 calls per second, or any other number of calls per second. Traditional conference calls have problems with the quality of their calls when the number of participants exceeds, for example, 200 people. In the phone system described herein, there is only one speaker (or a limited number of speakers), therefore the quality of the calls are relatively high for all listeners. In this regard, according to one embodiment, the phone call is uni-directional in that the VIP (the speaker or the limited number of speakers) is able to transmit the voice call content in real or near real-time, but the one or more listeners are unable to respond back to the VIP or the other listeners.

The phone system as described herein may be used by a plurality of VIPs. For example, musicians may, prior to a concert, initiate a voice call for their fans telling them about the playlist for the concert and/or play a warm-up song over the voice call. As another example, an athlete may connect with his or her fans after a big game, initiating a voice call about the game to the fans. As another example, an author of a popular cooking blog may create a voice call with his or her latest recipe. As another example, a politician may provide a voice call related to his or her campaign.

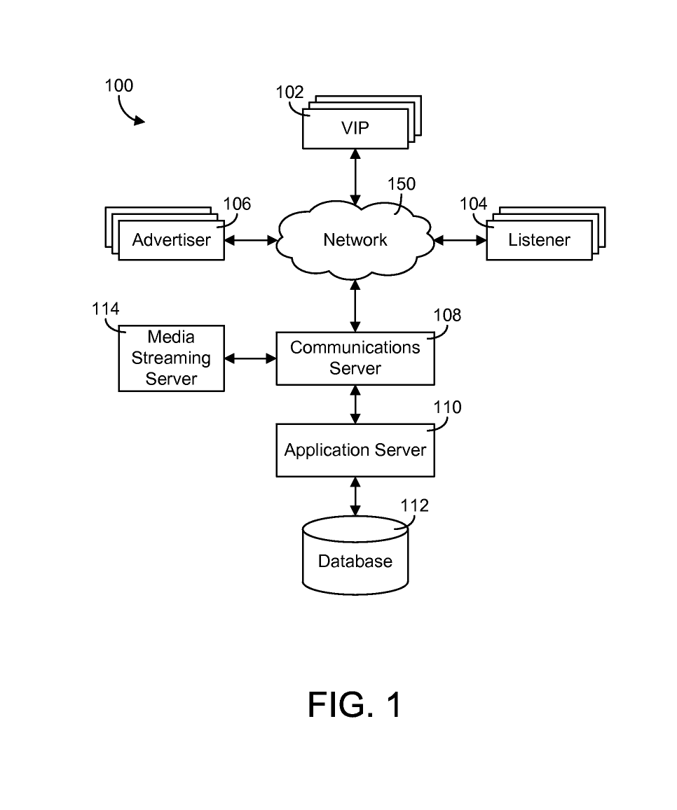

Referring now to FIG. 1, a block diagram of a system 100 for implementing the apparatuses and methods herein is shown. Phone system 100 generally includes a plurality of VIPs 102 and a plurality of listeners 104. VIPs 102 may provide voice call content to be streamed to the plurality of listeners 104 via a communications server 108 and media streaming server 114. For example, a VIP 102 may dial a phone number to connect with phone system 100 and provide voice call content. Phone system 100 in turn may contact a plurality of listeners 104 and stream the voice call content to the listeners in real-time or near real-time (e.g., with a slight delay such as 5 seconds, 10 seconds, 15 seconds, etc.).

Listeners 104 may sign up to receive a phone call with the voice call content provided by a VIP 102. In various embodiments, listeners 104 may pay or subscribe to phone system 100 to receive phone calls, and may choose one or more VIPs 102 from which he/she would like to receive voice calls. Phone system 100 may be configured to prioritize listeners or divide listeners into tiers based on various factors, such as geography, social connections, subscriptions to the phone system, previous interaction with the phone system, by chance, etc. Phone system 100 may prioritize or divide the listeners into tiers in order to lessen the load of the system by avoiding contacting too many listeners at once, burdening the system.

Phone system 100 further includes a communications server 108 configured to facilitate communications between VIPs 102 and listeners 104. Communications server 108 may be, for example, a FreeSWITCH server. Communications server 108 is shown coupled to a media streaming server 114 configured to stream (e.g., provide, transmit, etc.) a voice message provided by a VIP 102 in real-time. Communications server 108 is also shown coupled to an application server 110 configured to manage communications between VIPs 102 and listeners 104. For example, application server 110 may determine which listeners 104 to contact with voice call content from a VIP, may manage VIP accounts and listener accounts and subscriptions, may handle revenue generated through the use of phone system 100, and may handle other phone system 100 operation. Application server 110 is coupled to a database 112 storing VIP and listener information.

Phone system 100 may further include one or more advertisers 106 (or other third-party providers) which may provide further services to the phone system. For example, advertisers 106 or other third-party providers may provide content associated with a voice call, and may provide an additional revenue source for VIPs 102 and phone system 100. According to one embodiment, the advertisers 106 may provide an advertisement during the call (e.g., prior to initiation of the call, after the call has ended, etc.) between the source caller and one or more listeners. The advertisement may include, but is not limited to, a pre-recorded advertisement, a plurality of advertisements, etc. The amount and frequency of providing advertisements may be based on a subscription level of the listener (e.g., a basic subscription may correspond with a relatively higher amount of advertisements whereas a premium subscription may correspond with no or a limited amount of advertisements).

The various components of phone system 100 may communicate with one another via a network 150. In various embodiments, network 150 may include a computing network (e.g., LAN, WAN, Internet, etc.) to which VIPs 102 and listeners 104 may be connected via any type of network connection (e.g., wired, such as Ethernet, phone line, power line, etc., or wireless, such as WiFi, WiMAX, 3G, 4G, satellite, etc.). In some implementations, network 150 may include a media distribution network, such as cable (e.g., coaxial metal cable), satellite, fiber optic, etc., configured to distribute media programming and/or data content.

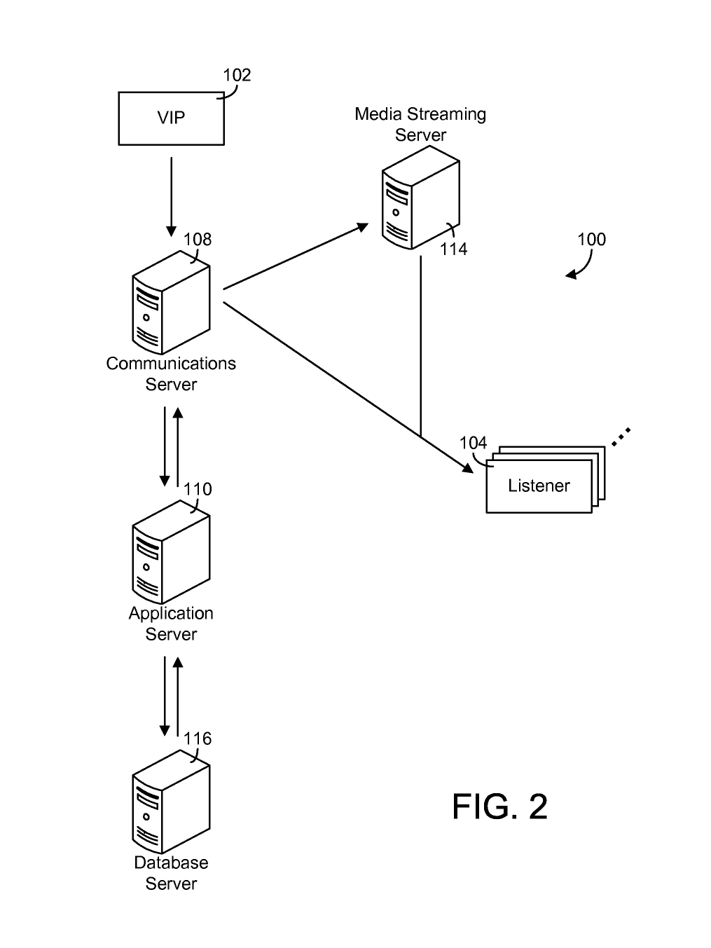

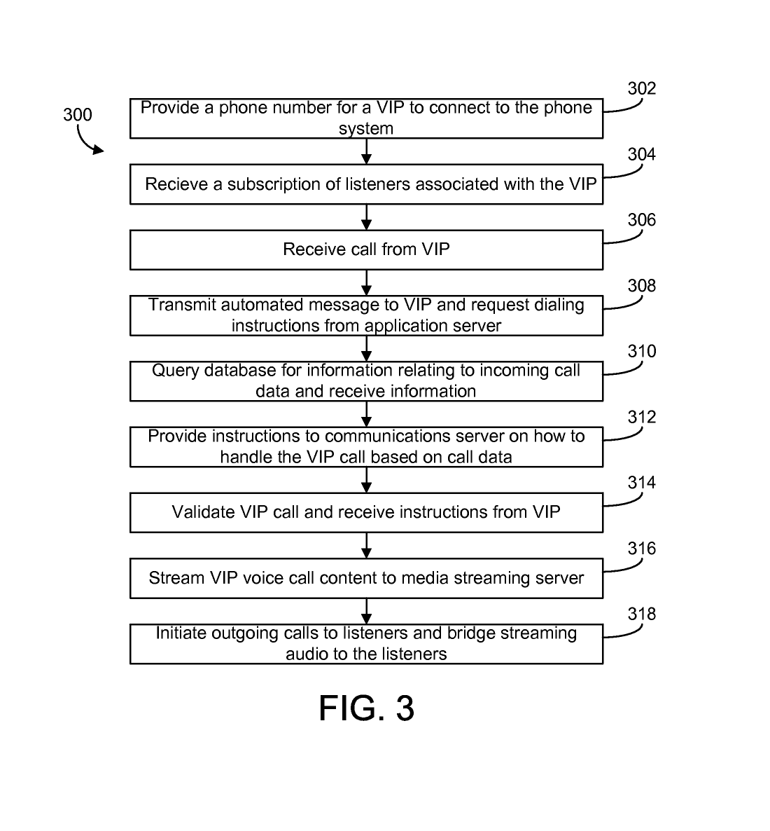

Referring now to FIGS. 2-3, a process of a VIP 102 providing voice call content for a plurality of listeners 104 is shown in greater detail. A VIP 102 may be registered or signed up with phone system 100 (such an onboarding process is described in greater detail in subsequent figures). According to one embodiment, upon registration, a VIP 102 is provided with their own VIP-specific phone number. In operation, the VIP 102 may dial their designated phone number for providing voice call content to a plurality of listeners 104. Communications server 108 may receive the phone call from VIP 102. Communications server 108 may be any type of server configured to manage communications between VIPs and listeners. Communications server 108 may be, for example, a FreeSWITCH server.

Communications server 108 may provide an automated message to VIP 102. The automated message may provide instructions or options to the VIP for leaving a voice message for listeners 104. For example, the automated message may serve as a menu that allows the VIP to choose between initiating a voice call, sending a voice message to all of his or her subscribers, to a particular subset of subscribers, to initiate a private call with a single subscriber, to pre-record a message to be sent to listeners in the future, etc. Communications server 108 may also request and/or receive dialing instructions from application server 110. The dialing instructions may relate to how communications server 108 interacts with VIP 102 and listeners 104. For example, the dialing instructions may include which listeners are subscribed to the VIP, instructions or options to provide the VIP, and other information relating to previous interactions between the VIP and his or her listeners.

Communications server 108, in one embodiment, may be split into incoming and outgoing servers. Incoming servers may manage incoming calls from VIPs and outgoing servers, may manage outgoing calls to listeners. In other embodiments, media streaming server 114, communications server 108, and/or application server 110 are integrated together. For example, some communications servers 108 may include a media streaming module.

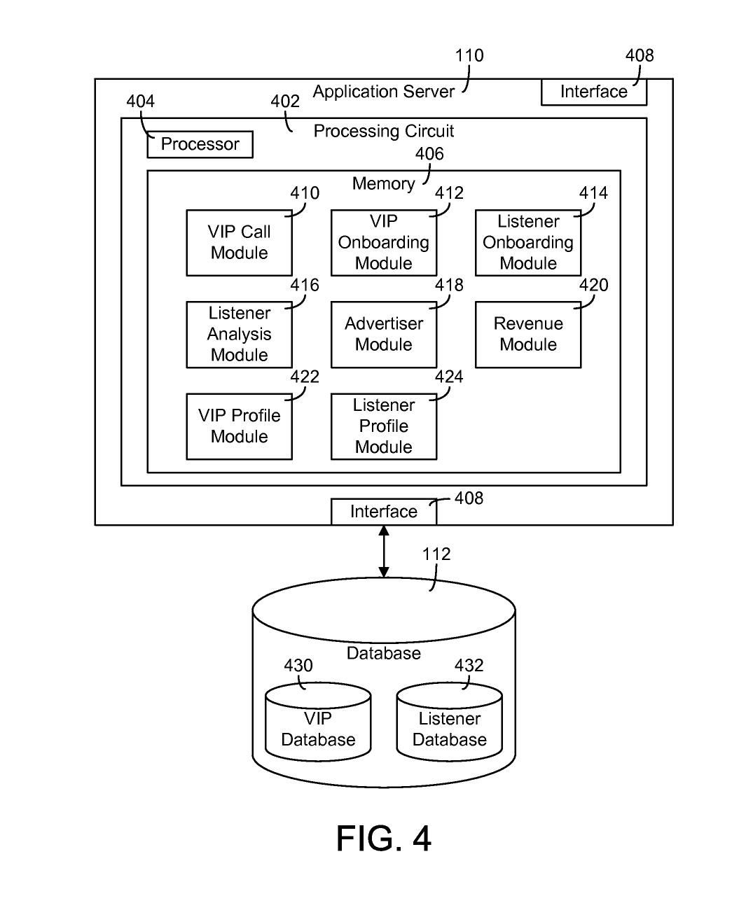

Application server 110 may generate the dialing instructions based on information retrieved from database 112 via database server 116. Database server 116 retrieves VIP profile information that may allow application server 110 to determine what features and options to provide to the VIP. Database server 116 further retrieves listener profile information that may allow communications server 108 to contact the plurality of listeners 104. Application server 110 may receive the VIP profile information and listener profile information from the database server 116 and prioritize listeners or organize listeners into tiers. The activities of application server 110 are described in greater detail in FIG. 4.

Communications server 108 may receive the dialing instructions from application server 110. Communications server 108 may validate the call and any options chosen by VIP 102. VIP 102 may then begin to provide the voice message (i.e., begin speaking). For example, the VIP may be asked to input a validation code (e.g., a personal identification number) to verify the identity of the VIP before the phone call is commenced. In one embodiment, upon validation, communications server 108 begins streaming the voice call content to media streaming server 114. Media streaming server 114 is configured to receive and stream the voice call content to a plurality of listeners.

As mentioned above, according to one embodiment, the phone call is uni-directional in that the VIP is able to transmit the voice call content in real-time or near real-time, but the one or more listeners are unable to respond back to the VIP or the other listeners. In other words, while the VIP is talking, the listeners are unable to respond to the VIP; the listeners are also unable to talk amongst themselves during the phone call. In this regard, the phone system is truncated to one or a small number of active participants (i.e., speakers) relative to a plurality or large number of listeners. This phone system structure decreases the burden on the telecommunications network supporting the phone call, which enables the transmission of the voice call content to be at a relatively high level. In turn, the phone call closely mimics a real phone call. This may appeal to listeners and increase the usage of the phone system. This feature may also appeal to VIPs and increase their usage of the phone system. The combination of these features may draw advertisers to the phone system as well. According to other embodiments, the phone call may be bi-directional or include limited bi-directionality. Bi-directionality refers to the ability of the listener to respond to the VIP and their response being provided to the VIP (in uni-directional calls, their response is blocked from being transmitted to the VIP by, e.g., the application server or communications server). An example of this bi-directionality is as follows: the VIP may broadcast over an advertising channel (e.g., a radio show) that they plan to call one lucky listener (e.g., fan) tonight using their VIP-specific phone number. The VIP dials into the phone system, the phone system validates the VIP, and the VIP requests the phone system to call a random subscriber. In another embodiment, the VIP may be able to view their list of subscribers and choose the subscriber to call themselves. The phone system at random dials a subscriber and the VIP is able to engage in a conversation with that subscriber. In this regard, the phone number used by the VIP is their VIP-specific phone number as compared to their personal mobile or home phone number. As such, the VIP still maintains a level of privacy relative to the subscriber. In other embodiments, the VIP may desire to conduct a bi-directional phone call with a small group of subscribers. The phone system may connect that VIP to a random group or a group chosen by the VIP. Thus, a wide array of phone call types are possible with the phone system. All such variations are intended to fall within the spirit and scope of the present disclosure.

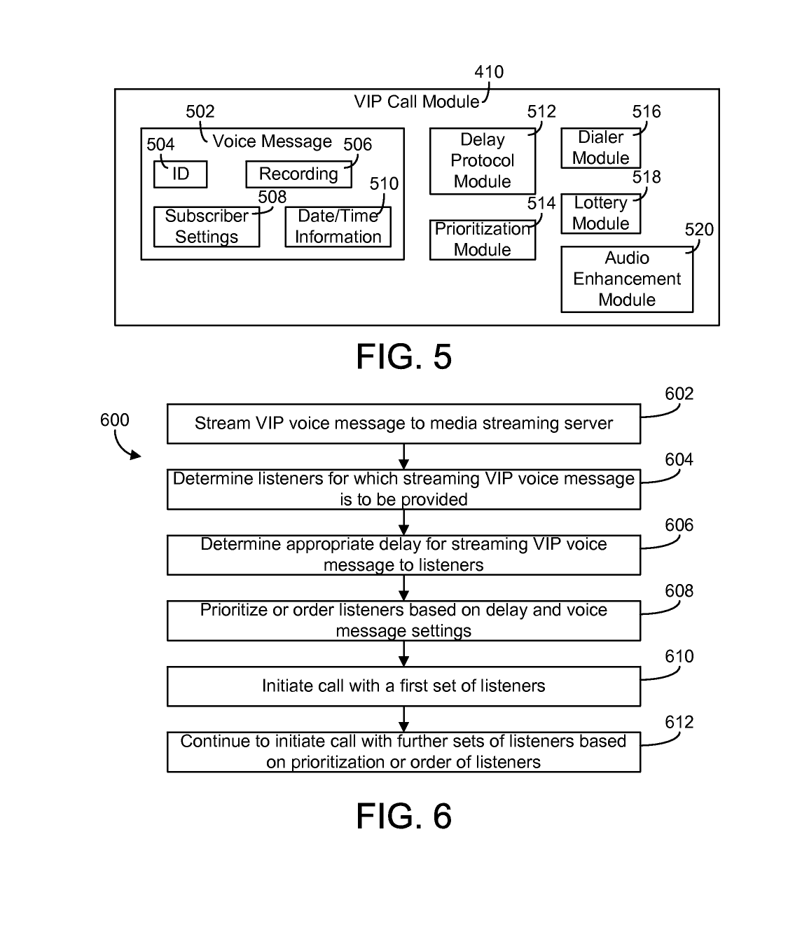

While VIP 102 is providing the voice call content, or after VIP 102 has provided the voice call content, communications server 108 may begin contacting listeners 104 based on the dialing instructions. In various embodiments, listeners 104 may be contacted all at once, via tiers (e.g., one group at a time), or in any other manner as defined by the dialing instructions. Accordingly, the dialing instructions may include to make the phone call uni-directional or bi-directional. Communications server 108 may include an auto dialer or other mechanism for placing calls to listeners 104. According to one embodiment, for each listener 104 contacted, after receiving confirmation or other input from the listener, the streaming audio received at media streaming server 114 is bridged directly to the listener. According to another embodiment, the subscription of listeners following the VIP that are called are provided the voice call content without interruption (e.g., without a listener input such as confirming that they would like to receive the call or not receive the call; rather, upon answering their phone, the voice call content is provided almost immediately (e.g., there may be a delay in transmission)). In this regard, the voice call content is provided in as close of a relationship to an actual phone call as may be possible. The process of contacting and streaming the voice message to a listener is described in greater detail in FIGS. 5-6.

In one embodiment, to help with scaling, servers 108, 110, 114, 116 may be in a clustered formation behind a load balancer. This distributes the workload across multiple computing resources, which may allow phone system 100 to be implemented for a large number of VIPs 102 and listeners 104.

In one embodiment, database 112 may be a relational database. In another embodiment, database 112 may be a document oriented database. In other embodiments, database 112 may be any other type of database configured to store VIP and listener information. Database server 114 may be a clustered environment with load balancing and failover to minimize downtime.

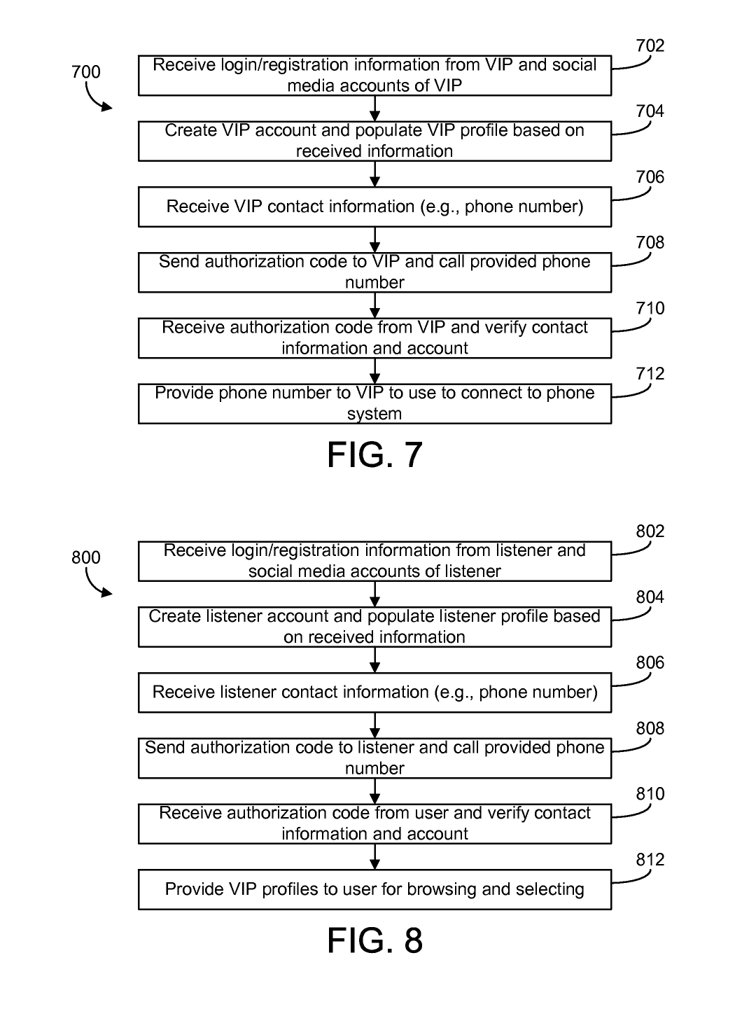

Referring more particularly to FIG. 3, a flow chart of a process 300 for receiving a voice call from a VIP and providing the voice call content to a plurality of listeners is shown. Process 300 includes providing a phone number for a VIP to connect to the phone system (step 302). For example, step 302 may be executed at the end of a VIP onboarding process (as described in FIG. 7). The phone number may be used by the VIP to connect to the phone system in order to provide voice messages to his/her listeners.

Process 300 further includes retrieving a subscription of listeners associated with the phone number of the VIP (step 304). For example, step 304 may be executed at the end of a listener onboarding process (as described in FIG. 8). In one embodiment, the listener may subscribe to a VIP, and the phone system may associate the listener with a phone number associated with the VIP. In another embodiment, the VIP may provide a phone number (or other contact information) that allows the listener to, upon calling the phone number, choose to subscribe to the VIP. This information is then received by the phone system at step 304. Steps 302, 304 may be executed prior to receiving an indication from a VIP that the VIP wishes to create and provide a voice message for his or her fans.

Process 300 includes receiving a voice phone call from the VIP (step 306). The VIP may use a phone number (or other contact information) to connect with the phone system. According to one embodiment, the VIP uses their specific phone number; in other words, the phone number provided in step 302.

Process 300 further includes transmitting an automated message to the VIP, and requesting dialing instructions from the application server (step 308). The automated message may include instructions for the VIP for how to provide the phone message, and may include options for the VIP as to who receives the voice call content. For example, the VIP may select a subset of listeners, a single listener, or any other option relating to which listeners receive the voice message, and when they receive it. In some embodiments, the automated message may include a request as to whether the VIP would like the call to be standard uni-directional or bi-directional. In one embodiment, the automated message may include options for the VIP relating to the VIP account that may be unrelated to providing a particular voice message for listeners.

Process 300 further includes the application server querying a database for information relating to the incoming call data and receiving the information at the application server (step 310). For example, based on the incoming call data, the application server may retrieve profile information for the VIP and for the listeners for whom the VIP would like to create a voice call.

Process 300 further includes the application server providing instructions to the communications server on how to handle the VIP call based on the call data (step 312). For example, based on the VIP profile, instructions relating to which listeners to contact, and when to contact each listener, may be provided to the communications server.

Process 300 further includes validating the VIP call and receiving instructions from the VIP (step 314). The instructions may include, for example, to begin receiving the voice call content.

Process 300 further includes streaming the VIP voice call content to the media streaming server (step 316). The media streaming server is configured to receive the voice call content and to stream the voice call content to a plurality of listeners that connect to the media streaming server. The media streaming server is configured to stream the voice call content from the beginning for each listener that connects to the media streaming server. According to one embodiment, the voice call content is structured as real time or near real time voice audio from the VIP. The “near” real time designation refers to the possible delays in transmission from providing the voice call content and transmitting that voice call content to the one or more users. According to another embodiment, the voice call content may include, but is not limited to, pre-recorded messages, video messages (pre-recorded or in real or near real time), and the like.

Process 300 further includes initiating outgoing calls to listeners and bridging streaming audio to the listeners (step 318). The order and time in which outgoing calls are placed to listeners may be based on a prioritization of the listeners (e.g., which listeners to call first). After connecting with the listener and verifying that the listener wants to listen to the voice message, the media streaming server may begin streaming the voice message to the listener.

Referring now to FIG. 4, the activities of application server 110 are shown in greater detail. Application server 110 may generally be configured to manage the interaction between the plurality of VIPs 102 and listeners 104. For example, application server 110 may manage VIP and listener accounts, allow VIPs and listeners to sign up for the service, determine how and in what order listeners are contacted, and provide other such features for phone system 100. In one embodiment, application server 110 may provide an onboarding process in which a VIP or listener signs up or registers for the services provided by the phone system. In one embodiment, application server 110 may use one or more algorithms to prioritize listeners, or to divide listeners into tiers. The prioritization of the listeners may then be used to determine when listeners are contacted when a VIP provides a voice message. In one embodiment, application server 110 may select which listeners are provided voice call content. In one embodiment, application server may facilitate advertiser involvement in the phone system (i.e., allowing advertisers to provide advertisements associated with the VIP or a voice message to a listener). In one embodiment, application server 100 may facilitate a payment system by which, for example, VIPs may be paid for use of the system, or may facilitate a subscription system by which listeners and VIPs pay for access to the phone system or pay per voice call received by a listener.

Application server 110 is shown to include a processing circuit 402 including a processor 404 and memory 406. Processor 404 may be implemented as a general purpose processor, a microprocessor, a microcontroller, an application specific integrated circuit (ASIC), one or more field programmable gate arrays (FPGAs), a CPU, a GPU, a group of processing components, or other suitable electronic processing components. Memory 406 may include one or more devices (e.g., RAM, ROM, Flash® memory, hard disk storage, etc.) for storing data and/or computer code for completing and/or facilitating the various processes, layers, and modules described in the present disclosure. Memory 406 may include volatile memory or non-volatile memory. Memory 406 may include database components, object code components, script components, or any other type of information structure for supporting the various activities and information structures described in the present disclosure. In some implementations, memory 406 is communicably connected to processor 404 and includes computer code (e.g., the various modules stored in memory 406) for executing one or more control processes described herein.

Application server 110 is further shown to include an interface 408 configured to facilitate communications between the application server and various other components of phone system 100 (e.g., communications server 108, database 112, etc.). Interface 408 may be configured to communicate with the various other components via a wired or wireless connection.

Memory 406 is shown to include various modules for completing the activities described herein. While memory 406 shows the various modules housed in the same memory, it should be understood that in various embodiments, the activities of application server 110 may occur in multiple different memory devices.

Memory 406 is shown to include a VIP call module 410. VIP call module 410 may generally be configured to set up a phone call with a plurality of listeners and to provide the communication server with appropriate instructions and content. In other words, VIP call module 410 may facilitate the activities of receiving voice call content from the VIP and providing the voice call content to the listeners as described with respect to FIGS. 2-3. VIP call module 410 is shown in greater detail in FIG. 5.

In some embodiments, VIP call module 410 is configured to prioritize which listeners to send or transmit the voice call content to first. For example, if a VIP has a significant number of subscribers such that it would be a burden on the phone system to attempt to provide a voice message from the VIP to all the listeners at the same time, VIP call module 410 may prioritize which listeners should hear the voice message first, or divide the listeners into tiers and call one tier at a time. In one embodiment, the prioritization may be made based on geography (i.e., listeners on the east coast are in one tier while listeners on the west coast are in another tier). In another embodiment, the prioritization may be made based on the listeners' previous interaction with the phone system. For example, listener analysis module 416 may provide VIP call module 410 with information relating to listener behavior. VIP call module 410 may then prioritize listeners who are more likely to accept the voice call content.

Memory 406 is shown to include a VIP onboarding module 412. VIP onboarding module 412 may generally be configured to facilitate a VIP signing up or registering with the phone system. A VIP may access the phone system via a browser in a webpage, via an application on a mobile device, or otherwise, to register with the phone system. The VIP may provide his or her information (e.g., name, contact information such as a phone number, profile information, social media contact information, etc.). For example, the VIP may provide Facebook or Twitter information that VIP onboarding module 412 may use to create or modify a VIP profile on the phone system. The VIP may then further modify the profile, or the VIP may create his or her own profile with the phone system.

After creation of the VIP profile, the VIP onboarding module 412 is structured to provide a phone number corresponding with the specific VIP. The phone number may be the personal phone number used by the VIP to create voice calls to provide to listeners. The phone number may be, for example, a mobile phone number associated with the VIP. The phone number may be used by the phone system in the future to help verify the VIP identity before the creation of a voice message.

Upon receiving the phone number, the phone system may transmit an authorization code to the phone number. The phone system may then call the provided phone number and ask for the authorization code. The VIP may provide the authorization code, thereby verifying the phone number as belonging to the VIP. In other embodiments, other methods of verifying the phone number provided by the VIP may be used. After verification, the phone system may send a message to the VIP including a phone number that the VIP may call into. The phone number may be used by the VIP in order to provide a voice message to listeners. The activities of VIP onboarding module 412 is described in greater detail in FIG. 7.

Memory 406 is shown to include a listener onboarding module 414. Listener onboarding module 414 may generally be configured to facilitate a listener signing up or registering with the phone system. A listener may access the phone system via a browser in a webpage, via an application on a mobile device, or otherwise, to register with the phone system. The listener may provide his or her information (e.g., name, contact information such as a phone number, profile information, social media contact information, etc.). For example, the listener may provide Facebook or Twitter information that listener onboarding module 414 may use to create or modify a listener profile on the phone system. The listener may then further modify the profile, or the listener may create his or her own profile with the phone system.

After creation of the listener profile, the listener may provide a phone number. The phone number may be used by the listener to receive voice call content from VIPs. The phone number may be, for example, a mobile phone number associated with the listener. Upon receiving the phone number, the phone system may transmit an authorization code to the phone number. The authorization code may be displayed, for example, on the screen of the mobile phone of the listener. The phone system may then call the provided phone number and ask for the authorization code. The listener may provide the authorization code, thereby verifying the phone number as belonging to the listener. In other embodiments, other methods of verifying the phone number provided by the listener may be used.

Once the phone number is verified, the listener may begin to receive calls from VIPs. The listener may be able to subscribe or one or more VIPs from which the listener may receive voice messages. For example, the listener may access a webpage on a browser, an application on a mobile device, or via another method to view a list of VIPs. The listener may then choose one or more VIPs to subscribe to, along with various other options related to the VIPs. Subscriptions are described in greater detail with relation to listener profile module 424.

In another example embodiment, as described below in regard to FIG. 11, the listener may subscribe by calling the VIP-specific phone number. At which point, the application server provides the VIP with one or more prompts on whether they would like to subscribe to or follow that VIP. Upon confirmation, the listener may begin to receive voice call content from the VIP.

Memory 406 is shown to include a listener analysis module 416. Listener analysis module 416 may generally be used to determine which listeners to prioritize when voice call content is transmitted to a plurality of listeners. When a significant number of listeners are subscribed to a VIP (e.g., beyond a threshold number of subscribed listeners such as 1,000 or 10,000 listeners) such that it is not feasible to call all the listeners at once to stream a voice message, listener analysis module 416 may be used to determine in what order listeners are to be called.

For example, listeners may be prioritized based on geography. Listeners on the east coast may be provided the voice message before listeners on the west coast. In another example, the VIP may select a region of interest. The application server assembles subscribers in that region of interest and prioritizes them other listeners. The application server may assemble subscribers in regions adjacent to the region of interest into a second tier and all other listeners into a third tier. The phone system then calls the first tier, second tier, and third tier of subscribers in that order. In this regard, the subscribers have been prioritized based on location. For example, a musician may want to announce to his/her subscribers their next tour stop to the subscribers in that area to give them a first chance at tickets.

As another example embodiment, listeners may be prioritized based on previous interaction with the phone system. If a listener often accepts a voice message from a VIP, that listener may be prioritized over a listener who often declines to listen to a voice message when called by the phone system. Also, if a listener has interacted frequently with the VIP via social media, the listener may be prioritized as he/she is more likely to accept the voice message.

As another example, listeners may be prioritized based on listener account information. For example, some listeners may pay a fee to the phone system for use of the system, and such listeners may be prioritized. The listener account information may be managed by, for example, listener profile module 424. As another example, listeners may be prioritized based on the best possible call per second rates for the phone system or another technological basis.

Memory 406 is shown to include an advertiser module 418. Advertiser module 418 may be configured to facilitate advertiser involvement in the phone system. For example, advertisers may pay to provide an advertisement that is inserted at the beginning of a phone call to a listener, at the end of the phone call, or in the middle of the phone call. VIP call module 410 may then be configured to insert the advertisement in the voice call content. The advertisers may provide payment to the phone system for the advertisements. The payment may then be split between the phone system and the VIPs. The advertisements may be presented to the listeners for free (e.g., the listeners may not be charged for a particular phone call and voice message if the listener agrees to listen to the advertisement). Advertiser module 418 may further provide various features relating to general advertisement strategy (e.g., determining which advertisements to provide with a particular listener, VIP, or voice message).

Memory 406 is shown to include a revenue module 420. Revenue module 420 may be configured to manage revenue generated by use of the phone system. Revenue may be generated from at least one of a listener, the VIP, and an advertiser for using the phone system. For example, listeners may pay a subscription fee for use of the phone system. Listeners may pay a monthly or yearly fee to use the phone system, may pay for each VIP the listener subscribes to, may pay for premium services (e.g., to be prioritized more often when VIPs provide voice messages), or otherwise. Such subscriptions and other fees may be managed via listener profile module 424. As another example, advertisers may pay the phone system in exchange for providing advertisements with the voice messages to the listeners.

In some embodiments, the revenue generated by the listeners and advertisers may be provided to the VIPs. For example, a VIP may provide a voice message to provide to listeners. The revenue module 420 may provide, for example, 50% of all revenue generated by the voice message to the VIP. The generated revenue may relate to advertisements played for the listeners and subscription fees of the listeners that listened to the voice message.

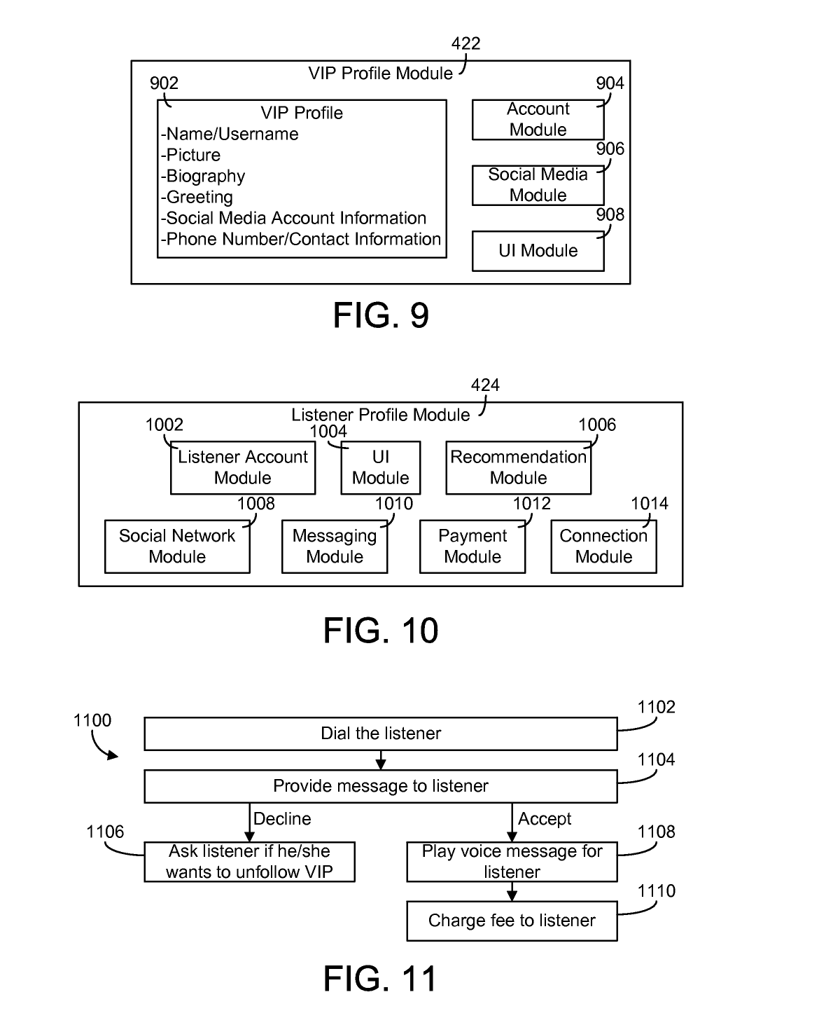

Memory 406 is shown to include a VIP profile module 422. VIP profile module 422 may be configured to manage profiles of the VIP for the phone system. For example, VIP profile module 422 may facilitate payment to VIPs for revenue generated by the VIP. As another example, VIP profile module 422 may create and modify a VIP profile to be presented to listeners. VIP profile module 422 is shown in greater detail in FIG. 9. VIP profile module 422 may be coupled to database 112 via interface 408, and more particularly to a VIP database 430 configured to store VIP information for the phone system.

Memory 406 is shown to include a listener profile module 424. Listener profile module 424 may be configured to manage profiles of listeners for the phone system. For example, listener profile module 422 may use listener behavior to recommend VIPs to the listener. As another example, listener profile module 424 may manage a subscription the listener has with the phone system. In one embodiment, the subscription is a monthly or yearly subscription. In another embodiment, listener profile module 424 may charge the listener each time he or she receives a voice message from a VIP. Listener profile module 424 is shown in greater detail in FIG. 10. Listener profile module 424 may be coupled to database 112 via interface 408, and more particularly to a listener database 432 configured to store listener information for the phone system.

Referring now to FIG. 5, VIP call module 410 is shown in greater detail. VIP call module 410 may be configured to set up a phone call with a plurality of listeners, transmitting a voice message provided by a VIP. The activities of VIP call module 410 may be executed upon receiving verification of a VIP calling into the phone system and wanting to leave a voice message to stream to a plurality of listeners.

VIP call module 410 may determine various properties relating to the voice message to be transmitted to listeners. For example, for a given voice message 502, VIP call module 410 may identify an ID 504 (e.g., an identification code, a personal identification number, an identification phrase or word, etc.), recording 506, or other information identifying the stream of the voice message in media streaming server 114 in order to validate the VIP or source caller. VIP call module 510 may further receive or identify subscriber settings 508 for the voice message. For example, a VIP may wish to leave a voice message for all of his or her subscribers, and subscriber settings 508 may indicate that the voice message should go to all subscribers. As another example, a VIP 102 may have “basic subscribers” who subscribe for free, and “premium subscribers”, who pay a fee for the subscription. Subscriber settings 508 may then indicate if a particular voice message should go to just the premium subscribers. As yet another example, a VIP 102 may choose to make a voice message free of charge to the listeners. Subscriber settings 508 may further include date/time information 510. Date/time information 510 may relate to when the voice message was created, when the voice message should be sent out to listeners, and when the voice message “expires”. Date/time information 510 may further include information about when the voice message is scheduled to be sent out, if the voice message is pre-recorded by the VIP.

VIP call module 410 is shown to include a delay protocol module 512 and prioritization module 514 for determining a method of calling listeners. Delay protocol module 512 may be configured to determine an acceptable delay between the time the VIP begins to provides a voice message and the time the first listener begins to receive a stream of the voice message (first delay), and a delay between the time the first listener begins to receive the stream of the voice message and the time the last listener beings to receive the stream of the voice message (second delay). For example, delay protocol module 512 may determine an acceptable delay for the first delay is 25 seconds and an acceptable delay for the second delay is 75 seconds. The acceptable delay time may be based on technological limitations (e.g., as described above, for voice messages for a large number of listeners, it may not be possible to simultaneously deliver the voice messages to all listeners), listener location, listener usage of phone system 100, listener social interaction with the VIP, or any combination thereof. The delay time may further be based on any information related to the voice message or information provided by the VIP.

In one embodiment, the second delay may be minimized by increasing the first delay. This may allow as many listeners as possible to hear a voice message at as close to the same time as possible. In various other embodiments, the relationship between the first delay and second delay may be optimized in any way.

Prioritization module 514 may prioritize listeners based on the delay information generated by delay protocol module 512 and other factors. Listeners who are prioritized may receive voice call content before other listeners. Prioritization module 514 may, for example, divide listeners who are to receive a voice message from a VIP 102 into tiers. A first tier may include between 2 and 1,000 listeners, between 1,001 and 10,000 listeners, between 10,001 and 100,000 listeners, between 100,001 and 1,000,000 listeners, or any other number of listeners. Further, there may be any number of tiers (2 tiers, 3 tiers, 4 tiers, and so forth).

As one example, listeners 104 may be prioritized based on how often listeners use phone system 100. A listener that frequently uses phone system 100 may receive a voice message before a listener that occasionally uses phone system 100. As another example, the geographic location of the listener may be used (e.g., east coast listeners receive the voice message before west coast listeners). As another example, social connections, social graphs, or other social media-related information may be used (e.g., listeners that often interact with social media of the VIP may be prioritized). In one embodiment, a social graph may be used to identify a group of related listeners that can be called at the same time. As another example, a listener that frequently declines VIP voice messages may be de-prioritized compared to listeners that often accept VIP voice messages.

VIP call module 410 is shown to include a dialer module 516. Dialer module 516 may be configured to set up phone calls to the plurality of listeners for the voice message.

VIP call module 410 is shown to include a lottery module 518. Lottery module 518 may be configured to select one or more listeners from a plurality of listeners eligible to receive the voice call content. For example, a VIP may choose to send a voice message to one (or more than one) listener, and VIP call module 410 may be configured to randomly select the one or more listeners. The selection of the listener may be random or weighted based on listener interaction with the VIP and phone system 100.

VIP call module 410 is shown to include an audio enhancement module 520. Audio enhancement module 520 may be configured to enhance the audio provided by the VIP and to enhance the voice message provided to the plurality of listeners. For example, audio enhancement module 520 may improve the audio quality of the voice message. As another example, audio enhancement module 520 may add music or other background noise to the voice message, or add in any other sound as appropriate for the voice message.

VIP call module 410 may further support other customization activities for a particular call. For example, a call may be made in real time or near real-time (i.e., “on demand”), or a call with the voice message may be scheduled in advance. As another example, the VIP may choose to provide a recording of the voice message to a listener via email (or other contact method) if desired.

As another example, a VIP may set up a voice message via a webpage on a browser, via an application on a mobile phone, or otherwise. In one embodiment, a VIP may enter call information via a webpage or application, such as a title and description of the voice call, scheduling information (e.g., when the voice message will be distributed), if the call is to be public (for all subscribers) or private (only for particular subscribers, or for subscribers with a particular password), whether to invite non-subscribers (and identifying such guests) to receive the voice message, a maximum number of listeners for the voice message, and the like.

Referring now to FIG. 6, a flow chart of a process 600 for providing a voice message to a plurality of listeners is shown, according to an exemplary embodiment. Process 600 may be executed upon the phone system verifying that a VIP wishes to leave a voice message to a plurality of listeners. Process 600 includes streaming a VIP voice message to the media streaming server (step 602).

Process 600 further includes determining listeners for which the streaming VIP voice message is to be provided (step 604). For example, a voice message from a VIP may be provided to all listeners who are subscribed to the VIP. As another example, a voice message from a VIP may be provided to a subset of listeners subscribed to the VIP (e.g., premium subscribers to the VIP, subscribers selected manually by the VIP, etc.).

Process 600 further includes determining an appropriate delay for streaming the voice message to the listeners (step 606). For example, step 606 may include determining a delay between the VIP providing the voice message and the time the voice message is streamed to listeners. The delay may occur based on the number of subscribers (as mentioned above, since it may not be possible to dial all listeners at once, some listeners must be dialed before others).

Process 600 further includes prioritizing or ordering listeners (e.g., dividing the listeners into tiers) based on the delay and voice message settings (step 608). In one embodiment, premium subscribers of a VIP may be prioritized over basic subscribers. In another embodiment, listeners may be prioritized based on their geographic location. In another embodiment, listeners may be prioritized based on previous activity with the phone system.

Process 600 further includes initiating a call with a first set of listeners (step 610), and continuing to initiate calls with further sets of listeners based on the prioritization or order of listeners (step 612). Process 600 continues while there are listeners still to be called.

Referring to FIG. 7, a flow chart of a VIP onboarding process 700 is shown, according to an exemplary embodiment. Process 700 may be executed to allow a VIP to sign up or register with the phone system. Process 700 allows a VIP to create an account and set up a profile viewable by potential listeners.

Process 700 includes receiving login or registration information from the VIP and the social media accounts of the VIP (step 702). In one embodiment, the VIP may provide login information (e.g., a username and password) directly. In another embodiment, login information may be provided through various social media platforms the VIP is registered to (e.g., Twitter, Facebook, LinkedIn, etc.).

Process 700 includes creating the VIP account and populating a VIP profile based on the received information (step 704). In one embodiment, the VIP may provide profile information (e.g., name, occupation, biography, etc.) directly. In another embodiment, the VIP may provide account information from various social media platforms, and the phone system may be configured to create a VIP profile based on profile information from the various social media accounts. For example, the phone system may pull a Twitter handle, Facebook pictures, and other information and populate the VIP profile with the information automatically for the VIP. The VIPs may then, during or after onboarding process 700, update and revise the profile.

Step 704 may further include categorizing the VIP. For example, the VIP may be categorized and sorted by various areas of interest (e.g., musician, athlete, politician, etc.). The categorization may allow listeners to search for VIPs in a particular interest.

Process 700 includes receiving VIP contact information (step 706). For example, the VIP contact information may include the phone number (or multiple phone numbers) that the VIP wishes to contact the phone system with in the future. Contact information may further include information relating to all of the VIP's devices (e.g., personal computer, laptop, personal digital assistant, tablet device, mobile phone, etc.) that the VIP may wish to use to connect to the phone system. The phone system may be configured, during and after onboarding process 700, to synchronize activities for the VIP across multiple VIP devices.

Process 700 includes sending an authorization code to the VIP (step 708). For example, the phone system may send the authorization code to the screen of the device from which the VIP initiated onboarding process 700, may send the authorization code to the phone number provided by the VIP, or otherwise. Further, once the authorization code is provided, the phone system calls the provided phone number. The phone call may ask the VIP to enter the provided authorization code.

Process 700 includes receiving the authorization code from the VIP and verifying the contact information and account of the VIP (step 710). Process 700 further includes providing a phone number (or other contact information) to the VIP to use to connect to the phone system in the future (step 712). The phone number may be provided as a message (e.g., text, email, push notification, etc.). The VIP may save the phone number in his or her phone directory, for example. In the future, the VIP may access the phone system in order to leave a voice message to a plurality of listeners. For example, the VIP may dial the provided phone number to initiate the process described in FIGS. 2-3 for providing a voice message.

According to another embodiment, a VIP may be onboarded manually. For example, an operator of the phone system may establish a connection with a VIP. The VIP permits the operator to add them to the phone system for listeners to follow/subscribe to. The operator then provides the VIP with their VIP-specific phone number for the VIP to advertise or provide to listeners. Similar to this embodiment, the listener may then be onboarded manually (another embodiment relative to FIG. 8). This may happen as follows: the VIP advertises their VIP-specific number. A listener likes the specific VIP and decides to call their specific phone number. At which point, the listeners may be provided with an audio-guided menu to subscribe to the VIP and join the phone system generally. After this initial registration, voice call content may be provided to the listener without interruption from the VIP they subscribed to (e.g., the listener answers their phone from the VIP specific number and immediately begins to hear the VIP). Furthermore, after the initial registration, the listener may call VIP-specific numbers from other VIPs and grow their network of VIPs that call them. In some embodiments, the listener may be prompted to provide payment for the phone system service, as described above. These manual onboarding processes, in addition to the processes described below, are all intended to fall within the spirit and scope of the present disclosure.

Referring to FIG. 8, a flow chart of a listener onboarding process 800 is shown, according to an exemplary embodiment. Process 800 may be executed to allow a listener to sign up or register with the phone system. Process 800 allows a listener to create an account and to provide information that allows the phone system to provide options to the listener for following and subscribing to VIPs.

Process 800 includes receiving login or registration information from the listener and the social media accounts of the listener (step 802). In one embodiment, the listener may provide login information (e.g., a username and password) directly. In another embodiment, login information may be provided through various social media platforms associated with the listener (e.g., Twitter, Facebook, LinkedIn, etc.).

Process 800 includes creating the listener account and populating a listener profile based on the received information (step 804). In one embodiment, the listener may provide profile information (e.g., name, occupation, biography, etc.) directly. In another embodiment, the listener may provide account information from various social media platforms, and the phone system may be configured to create a listener profile based on profile information from the various social media accounts. For example, the phone system may pull a Twitter handle, Facebook pictures, and other information and populate the listener profile with the information automatically for the listener. The listeners may then, during or after onboarding process 800, update and revise the profile.

Process 800 includes receiving listener contact information (step 806). The listener contact information may include the phone number (or multiple phone numbers) from which the listener wishes to receive voice messages. Contact information may further include information relating to any other device or account the listener wishes to receive voice messages and other information (e.g., emails).

Process 700 includes sending an authorization code to the listener (step 808). For example, the phone system may send the authorization code to the screen of the device from which the listener initiated onboarding process 700, may send the authorization code to the phone number provided by the listener, or otherwise. Further, once the authorization code is provided, the phone system calls the provided phone number. The phone call may ask the listener to enter the provided authorization code.

Process 800 includes receiving the authorization code from the listener and verifying the contact information and account of the listener (step 810). Process 800 may further include providing VIP profiles to the listener for browsing and selecting (step 812), or any other information relating to general activity with the phone system. User interaction with the phone system (e.g., selecting VIPs to follow, subscribing or unsubscribing to VIPs, browsing a list of VIPs, etc.) is described with reference to FIG. 10.

Referring to FIG. 9, a detailed block diagram of a VIP profile module 422 configured to manage a VIP profile is shown, according to an exemplary embodiment. VIP profile module 422 may include VIP profile information 902. VIP profile information 902 may include a name or username for the VIP, a picture, a biography, a greeting, and other such information that may allow a listener to identify the VIP. VIP profile information 902 may further include social media account information (e.g., the Twitter handle of the VIP, a link to a Facebook page, etc.). VIP profile information 902 may further include information not visible to the listener, such as a phone number and other contact information of the VIP that may be used by the phone system to verify the identity of the VIP.

VIP profile module 422 is shown to include an account module 904. Account module 904 may be configured to manage an account of the VIP. As a VIP conducts calls with listeners and receives revenue from phone system 100, the VIP may be able to view his or her account balance of accumulated revenue. Once the VIPs have a minimum balance (e.g., $50), the VIPs may choose to have the money sent to a private bank account via account module 404. In one embodiment, the transfer of money may be facilitated by third-parties, such as PayPal.

In one embodiment, account module 904 may be configured to donate the account balance (or a portion thereof) to a charity or other source. Account module 904 may track the total amount donated by the VIPs to charity and display the amount for the VIP publically.

In one embodiment, account module 904 may be configured to manage how the VIP chooses to charge listeners for voice messages. For example, a VIP may choose to charge a particular amount per voice message. Account module 904 may facilitate payment of the charge with, for example, payment module 1012 of listener profile module 410. Account module 904 may then provide payment back to the VIP based on the activity related to the voice message.

VIP profile module 422 is shown to include a social media module 906. Social media module 906 may be configured to integrate use of the phone system with the various social media accounts of the VIP. VIP profile module 422 is further shown to include a UI module 908. UI module 908 may be configured to present a VIP with a user interface (via a browser or mobile device) that allows a VIP to view activity relating to voice messages (e.g., how many subscribers are following the VIP, revenue information, and the like). For example, UI module 908 may provide a user interface showing how much revenue the VIP is generating with his or her voice messages.

Referring to FIG. 10, a detailed block diagram of listener profile module 424 configured to manage a listener profile is shown, according to an exemplary embodiment. Listener profile module 424 may generally be configured to manage a listener profile of a listener signed up with the phone system.

Listener profile module 424 is shown to include a listener account module 1002. Listener account module 1002 may be configured to maintain a listener account. The listener account may include information about the listener, such as social media profiles of the listener, credit card information or other information usable to charge the listener for use of the phone system, and other such information. For example, listener account module 1002 may include notification information (e.g., if the listener should be notified about missed calls and provide call reminders), billing and payment information, and the like.

Listener profile module 424 is shown to include a user interface (UI) module 1004. UI module 1004 may be configured to display a list of VIPs to the listener. Once a listener establishes an account with the phone system, the listener may view profiles of various VIPs signed up with the phone system. In various embodiments, listeners may search for VIP profiles using a search engine and/or by browsing categories of VIPs. VIPs may be categorized and sorted by various areas of interest, including, but not limited to, music, sports, news, technology, fashion, TV, family, art and design, business, health, politics, travel, weather, etc. Listeners may be able to sort VIP profiles and to select a profile. The listeners may then select a “follow” button in order to receive voice call content from the VIP in the future. The listener may be presented with various other options relating to following the VIP (e.g., the VIP may have specialized options, a basic subscription or a premium subscription, and so forth). The listener may also be presented with details related to following the VIP (e.g., whether there are any charges associated with following the VIP or receiving voice messages from the VIP, whether or not voice messages can be previously scheduled by the VIP, etc.). UI module 1004 may generate a user interface for the listener that presents the list of VIPs to the user via an application on a mobile device, via a browser on a webpage, or otherwise.

Further, the listener may be able to unsubscribe to VIPs in a similar manner. UI module 1004 may present a list of subscribed VIPs to the listener, and the listener may select “unfollow” or select other options to manage the listener's subscriptions to VIPs.

In one embodiment, UI module 1004 may present a list of voice messages that are scheduled. For example, a list of upcoming calls from VIPs may be presented to the listener for selection.

In one embodiment, UI module 1004 may present a list of available voice messages from a particular VIP. For example, a VIP may have a list of scheduled upcoming voice messages, each call having a date and time. The listener may select to sign up to receive one or more (or all) of the voice messages. In one embodiment, each voice message may have a price or tokens associated with the call. The listener may select a voice message and prepay for the voice message. Payment module 1012 may be configured to manage any payment associated with selecting individual voice messages.

In one embodiment, the listener may be able to sign up for a basic or premium subscription (or any other number of levels) with a VIP. For example, a VIP may have a free basic subscription and a premium subscription in which the listener receives extra content for a fee. UI module 1004 may present the listener with various options for subscribing to the VIP in such a manner.

Listener profile module 424 is shown to include a recommendation module 1006. Recommendation module 1006 may be configured to determine recommendations to the listener on which VIPs to follow based on listener interests and behavior. For example, the listener may be recommended similar VIPs to the VIPs that the listener is already following. As another example, the listener may be recommended VIPs based on listener interests identified in the listener profile. As another example, the VIPs' and listener's social networks may be analyzed, and recommendation module 1006 suggests VIPs to the listeners based on such information.

Listener profile module 424 may include a social network module 1008. Social network module 1008 may establish subscriptions between listeners and VIPs based on the social media accounts of the listener. For example, if the listener is following a VIP in his or her social networks, social network module 1008 may be configured to establish a subscription automatically between the VIP and listener, or to suggest the subscription to the listener.

Listener profile module 424 further includes a messaging module 1010. After a listener subscribes to a VIP, messaging module 1010 may deliver a message (e.g., text, email) to the listener providing them with a unique phone number (and/or other contact information). In one embodiment, each subscription to a VIP may include a unique phone number; in other embodiments, multiple or all subscriptions may originate from the same phone number. The listener may save the phone number with the VIP name (or other identifier) in their contact directory. Therefore, the listener may be able to tell when he or she is being called with a voice message from a VIP.

Listener profile module 424 further includes a payment module 1012. In one embodiment, phone system 100 may charge a listener a fee (e.g., $0.25) for each call that he or she accepts from a VIP. In another embodiment, the fee may be variable (e.g., $0.25 to connect with additional costs per minute). In yet another embodiment, the fee may be established by the listener. For example, listeners may decide how much they want to “donate” to the VIP. The donation may occur prior to or at the start or end of a phone call from the phone system. Payment module 1012 may be configured to manage the various charges related to use of phone system 100. In other embodiments, some calls or other use of phone system 100 may be free to the listener, and payment module 1012 may be configured to manage the free use of the phone system.

In one embodiment, payment module 1012 may be configured to allow listeners to buy “credits” or “tokens”. A credit may be used each time the listener receives a voice message from a VIP. The listeners may purchase credits via payment module 1012. In one embodiment, a minimum number of credits (e.g., 20 credits for $5) may be required to be purchased. Payment module 1012 may further provide discounts for larger purchases of credits (e.g., if the listener purchases 90 credits, he or she receives 10 free credits). The dollar value of a credit may be a fixed amount (e.g., $0.25). In one embodiment, payment module 1012 may offer free credits when a listener signs up with phone system 100, and may further offer free credits through promotions, contests, and the like. Further, free credits may be offered as incentives for having “friends” of the listener sign up with phone system 100 or for other phone system activity.

Listener profile module 424 is shown to include a connection module 1014 configured to manage phone calls to the listeners. Referring also to FIG. 11, a process 1100 of connecting a listener to a stream of a VIP voice message is shown. Process 1100 includes dialing the listener (step 1102) and providing a message to the listener (step 1104). The message may indicate to the listener that a VIP the listener is subscribed to has created a voice message for the listener. The message may ask the listener to accept the call or decline the call.

If the listener declines the call, the listener may be asked if he or she wants to unfollow the VIP (step 1106). If the listener accepts the call, the stream of the voice message is played for the listener (step 1108) and the listener may be charged if there is a fee associated with the call (step 1110).

While FIG. 11 depicts a decision tree for the listener, as mentioned in one embodiment, the listener is provided with the voice call content directly upon answering their phone so to mimic a real phone call conversation as closely as possible. In this regard, the listener may be prompted or otherwise able to provide an input at another point during the call (e.g., prior to, in the middle of, after) to unfollow the VIP thereby preventing future voice call content from that VIP to the listener (step 1106). Similarly, payment information may also be determined at another point during the call if not otherwise set up. All such variations are intended to fall within the spirit and scope of the present disclosure.

Listener profile module 424 may further provide other features relating to listener usage of the phone system. For example, listeners may be ranked by listener profile module 424 based on the total number of calls or the total number of minutes the listener has participated in with a VIP. This information may be used by, for example, prioritization module 514 to prioritize and create tiers for listeners. As another example, listeners may rate VIPs, and the rating may be used by the phone system to incentivize VIPs.

The embodiments of FIGS. 10-11 describe an embodiment in which a listener may select a VIP via a user interface or other similar method via a browser, application, etc. In another embodiment of the present disclosure, the listener may be able to subscribe to a VIP in other ways. For example, a VIP may share a phone number (or other contact information), via social media, email, etc. The listener may dial into the phone number, connecting to the phone system, and choose to subscribe to the VIP. The listener may or may not have an account with the phone system (e.g., the listener may or may not have gone through the onboarding process). In such an embodiment, the listener may be able to subscribe to a VIP over the phone instead of through a user interface as described above.

The calls from the VIPs to the listeners may be on-demand or previously scheduled. The VIPs may inform the listeners about previously scheduled calls either through social media or through phone system 100.

In one embodiment, the length of each voice message is limited. For example, the real-time or near real-time voice call from the VIP to the listeners may be limited to five minutes because the cost of phone calls typically increases based on length of time.

In one embodiment, phone system 100 may support the integration of video and audio using the same delivery mechanism. The integration of audio and video may use a native application that streams data into the listener's device. Alternatively, in another embodiment, the integration of audio and video does not require a native application but establishes an experience just as seamless. In such embodiments, there are transcoder overlays on the streaming video. This may allow watermarks to be added to the video, which may allow advertisements or sponsorship opportunities associated with the streaming video to be provided.

In some embodiments, the systems and methods described herein may be adapted to allow a speaker for a VIP to provide voice messages instead of the VIP. For example, the VIP may designate one or more other speakers associated with the VIP, and the speakers may provide the voice message.

In some embodiments, the systems and methods described herein may be used to create different levels for VIPs (e.g., “elite” VIPs, regular VIPs, etc.). For example, VIPs who have more than 50 listeners for a voice message may be classified as elite VIPs, VIPs who have more than 100 followers or subscribers may be classified as elite VIPs, and so forth. The phone system may classify the VIPs and display such information to the listeners.

In some embodiments, the systems and methods described herein may be adapted to allow anyone to host a phone call (e.g., to leave a voice message for anyone who wishes to hear from the person). In such an embodiment, any person can be a “VIP”.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can include RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A phone system, comprising:
an application server configured to provide a phone number to a source caller to connect to the phone system, and to receive a subscription of listeners associated with the source caller; and
a phone server configured to receive voice call content from the source caller using the phone number;
wherein the application server is configured to cause the phone server to phone dial the subscription of listeners to provide the voice call content to the subscription of listeners based on a validation of the source caller.

2. The phone system of claim 1, wherein the voice call content is near real-time voice audio from the source caller.

3. The phone system of claim 1, wherein the application server is configured to divide the subscription of listeners into one or more tiers, wherein the application server is configured to cause the phone server to phone dial each tier of subscription of listeners in a priority arrangement based on an assigned tier.

4. The phone system of claim 3, wherein the assigned tier is based on at least one of a location of a listener, a previous interaction with the phone system, an interaction amount by the listener with the source caller via a social media platform, and whether the listener has paid a fee.

5. The phone system of claim 4, wherein listeners that have previously accepted voice call content are placed in an assigned tier that is in the priority arrangement relatively higher than listeners who have not previously accepted voice call content, such that the listeners who have previously accepted voice call content are dialed relatively sooner than listeners who have not previously accepted voice call content.

6. The phone system of claim 3, wherein listeners that have paid the fee are placed in an assigned tier that is in the priority arrangement relatively higher than listeners who have not paid the fee.

7. The phone system of claim 1, wherein the validation is based on receiving an identifying piece of information from the source caller.

8. A phone system, comprising:
a VIP onboarding module structured to facilitate registration by a VIP with the phone system, wherein the VIP onboarding module is structured to provide a phone number to the VIP based on registration;
a listener onboarding module structured to facilitate registration by a listener with the phone system;
a listener profile module structured to receive a selection to follow the VIP; and
a call module structured to receive voice call content from the VIP and set up a phone call with one or more listeners that have selected to follow the VIP.

9. The phone system of claim 8, wherein the voice call content is near real-time voice audio from the VIP, wherein the cell module is structured to provide the near real-time voice audio over the phone call upon a listener answering their phone without an input provided by the listener.

10. The phone system of claim 8, further comprising an advertising module, wherein the advertising module is structured to provide an advertisement to the listener during the phone call.

11. The phone system of claim 8, further comprising a revenue module, wherein the revenue module is structured to receive payment from at least one of the VIP, the listener, and an advertiser for using the phone system.

12. The phone system of claim 8, wherein the voice call content includes pre-recorded voice audio from the VIP, wherein the call module is structured to provide the pre-recorded voice audio on a schedule to the listener.

13. The phone system of claim 8, wherein for a plurality of listeners who have selected to follow the VIP beyond a threshold number of listeners, the call module is structured to prioritize the plurality of listeners into tiers, wherein each tier includes one or more listeners, and wherein the call module is structured to set up the phone call with each tier in a prioritized arrangement.

14. The phone system of claim 13, wherein the prioritized arrangement is based on at least one of a location of the one or more listeners, a previous interaction with the phone system by the one or more listeners, an interaction amount by the one or more listeners with the VIP via a social media platform, and whether the one or more listeners have paid a fee.

15. The phone system of claim 8, further comprising an audio enhancement module, wherein the audio enhancement module is structured to enhance the voice call content provided to the one or more listeners, wherein the enhancement includes an addition of background noise to the voice call content.

16. A method of operating a phone system, comprising:
providing a phone number to a source caller to connect to the phone system;
receiving a subscription of listeners associated with the source caller;
receiving voice call content from the source caller using the phone number; and
initiating an outgoing call for each listener in the subscription of listeners to provide the voice call content to the subscription of listeners.

17. The method of claim 16, wherein the voice call content is near real-time voice audio from the source caller.

18. The method of claim 16, further comprising prioritizing listeners to call first based on delay information.

19. The method of claim 18,
wherein the delay information includes a first delay corresponding to an amount of time between when the source caller provides the voice call content and when a first listener receives the voice call content;
wherein the delay information includes a second delay corresponding to an amount of time between when the first listener receives the voice call content and when a last listener receives the voice call content;
wherein prioritizing listeners based on delay information includes minimizing the second delay by increasing the first delay, such that a relatively greater number of listeners receive the voice call content at the same time.

20. The method of claim 16, further comprising prioritizing listeners to call first based on at least one of a location of a listener, a previous interaction with the phone system by the listener, an interaction amount by the listener with the source caller via a social media platform, and whether the listener has paid a fee.
